(19) United States
(12) Patent Application Publication
(10) Pub. No.: US 2017/0171594 A1
(43) Pub. Date: Jun. 15, 2017

(54) METHOD AND ELECTRONIC APPARATUS OF IMPLEMENTING VOICE INTERACTION IN LIVE VIDEO BROADCAST

(71) Applicants: Le Holdings (Beijing) Co., Ltd., Beijing (CN); LE SHI INTERNET INFORMATION TECHNOLOGY CORP. BEIJING, Beijing (CN)

(72) Inventors: Shuo Huang, Beijing (CN); Jiancheng Huang, Beijing (CN); Ruike Li, Beijing (CN)

(21) Appl. No.: 15/246,736

(22) Filed: Aug. 25, 2016

Related U.S. Application Data
(63) Continuation of application No. PCT/CN2016/088509, filed on Jul. 5, 2016.

(30) Foreign Application Priority Data
Dec. 14, 2015 (CN) 201510925679.X

(51) Int. Cl. H04N 21/422; H04N 21/47

(52) U.S. Cl. CPC H04N 21/42203; H04N 21/47

(57) ABSTRACT

Disclosed are a method and electronic apparatus of implementing voice interaction in a live video broadcast. The method includes: enabling a voice collection module when a continuous touch event occurring on a voice response control item in an interactive information page is detected; collecting voice data by voice collection module during the continuous touch event, and the live video broadcast page staying at muted state when the voice collection module collects the voice data; sending the voice data to an interaction platform so that the interaction platform pushes the voice data to each related user, wherein the related users comprise a user watching live video and a user broadcasting live video. The application resolves the technical problem at the present stage where applications of live broadcast permitting text type interaction lack timeliness, sufficient immediateness and friendliness.

### CROSS REFERENCE TO RELATED APPLICATIONS

This application is a continuation of International Application No. PCT/CN2016/088509, filed on Jul. 5, 2016, which is based upon and claims priority to Chinese Patent Application No. 201510925679.X, filed on Dec. 14, 2015, the entire contents of which are incorporated herein by reference.

### TECHNICAL FIELD

The application relates to an intelligent application field, more particularly to a method and electronic apparatus of implementing voice interaction in a live video broadcast.

### BACKGROUND

Application of live video broadcast as a new internet social has been well-known and purposes to provide users with convenient video sharing services anytime anywhere.

Applications of live video broadcast at the present stage implement the interaction between a broadcaster and audiences by mainly using texts. That is, each audience inputs texts in a commentary box by a keyboard of the apparatus and sends them and text commentaries of all the audiences are shown in a specific commentary region when watching a live video; and each audience can respond in voice during the live video broadcast when seeing these commentaries, so as to implement interaction in a live video broadcast.

However, in the case where the audiences comment by texts as the broadcaster responds voice, the two different types of interaction do not match the timeliness that applications of live broadcast should have, and text type interaction is direct insufficiently and lacks friendliness. In other words, applications of live broadcast permitting text type interaction at the present stage have technical problems where they lack timeliness, sufficient immediateness and friendliness, and to a certain extent, user experience will be affected.

### SUMMARY

Embodiments of the application provides a method and electronic apparatus of implementing voice interaction in a live video broadcast to resolve the technical problem at the present stage where applications of live broadcast permitting text type interaction lack timeliness, sufficient immediateness and friendliness.

In a first aspect, an embodiment of the application provides a method of implementing voice interaction in a live video broadcast, and the method includes:
enabling a voice collection module when a continuous touch event occurring on a voice response control item in an interactive information page is detected, wherein the interactive information page and a live video broadcast page are interrelated to each other;
collecting voice data by voice collection module during the continuous touch event, and the live video broadcast page staying at muted state when the voice collection module collects the voice data;
sending the voice data to an interaction platform so that the interaction platform pushes the voice data to each related user, wherein the related users comprise a user watching live video and a user broadcasting live video.

In a second aspect, an embodiment of the application provides a non-volatile computer storage medium, which stores computer-executable instructions, and the computer-executable instructions are used to execute any of the methods of implementing voice interaction in a live video broadcast in the application.

In a third aspect, an embodiment of the application provides an electronic apparatus, including:
at least one processor; and,
and a storage communicating with the at least one processor; wherein,
the storage storing instructions executable by the at least one processor, and when executed by the at least one processor, the instructions making the at least one processor perform any of the methods of implementing voice interaction in a live video broadcast in the application.

In the method and electronic apparatus of implementing voice interaction in a live video broadcast provided in embodiments of the application, voice data is received and transmitted to an interaction platform through an interactive information page of an application of live video broadcast and then is sent to an interactive information page of each related user by the interaction platform, so that the related users receive it for the implementation of voice interaction in a live video broadcast. This resolves the technical problem at the present stage where applications of live broadcast permitting text type interaction lack timeliness, sufficient immediateness and friendliness, so as to enhance user experiences; and the live video watched by the user collecting voice data is muted so that it can assure that the voice data is clear and accurate, so as to further enhance user experiences.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method of implementing voice interaction in a live video broadcast in an embodiment of the application;

FIG. 2 is another flow chart of a method of implementing voice interaction in a live video broadcast in an embodiment of the application;

FIG. 3 is a schematic view of determining a valid swiping distance in an embodiment of the application;

FIG. 4 is yet another flow chart of a method of implementing voice interaction in a live video broadcast in an embodiment of the application;

FIG. 5 is yet another flow chart of a method of implementing voice interaction in a live video broadcast in an embodiment of the application;

FIG. 6 is a block diagram of an electronic apparatus of implementing voice interaction in a live video broadcast in an embodiment of the application;

FIG. 7 is another block diagram of an electronic apparatus of implementing voice interaction in a live video broadcast in an embodiment of the application;

FIG. 8 is yet another block diagram of an electronic apparatus of implementing voice interaction in a live video broadcast in an embodiment of the application;

FIG. 9 is yet another block diagram of an electronic apparatus of implementing voice interaction in a live video broadcast in an embodiment of the application;

FIG. 10 is a block diagram of an electronic apparatus of implementing voice interaction in a live video broadcast in an embodiment of the application.

### DETAILED DESCRIPTION

To make the objectives, technical solutions, and advantages of the embodiments of the application more comprehensible, the following clearly describes the technical solutions in the embodiments of the application with reference to the accompanying drawings in the embodiments of the application. Apparently, the described embodiments are merely a part rather than all of the embodiments of the application. All other embodiments obtained by a person of ordinary skill in the art based on the embodiments of the application without creative efforts shall fall within the protection scope of the application.

### Embodiment 1

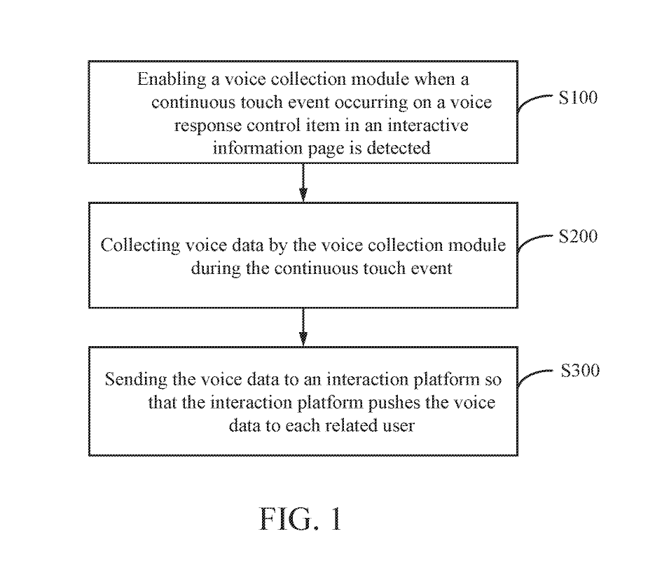

To resolve the technical problem at the present stage where applications of live broadcast permitting text type interaction lack timeliness, sufficient immediateness and friendliness, the Embodiment 1 of the application provides a method of implementing voice interaction in a live video broadcast. The method is based on an application of live video broadcast, which can be installed on a smart terminal, such as smart phones, tablet computers, and the application is not restricted to types of the smart terminal. This embodiment of the application is exemplarily described based on a smart phone as the smart terminal. Please refer to FIG. 1, which is a flow chart of a method of implementing voice interaction in a live video broadcast in the Embodiment 1 of the application, and the method includes:
step S100, enabling a voice collection module when a continuous touch event occurring on a voice response control item in an interactive information page is detected, wherein the interactive information page and a live video broadcast page are interrelated to each other;
step S200, collecting voice data by the voice collection module during the continuous touch event, and the live video broadcast page staying at muted state when the voice collection module collects the voice data;
step S300, sending the voice data to an interaction platform so that the interaction platform pushes the voice data to each related user, wherein the related users comprise a user watching live video and a user broadcasting live video.

In step S100, the interactive information page and the live video broadcast page are interrelated to each other, and particularly, the application of live video broadcast has many user pages, such as a live video broadcast page, an interactive information page and a live program information page.

The live video broadcast page is a page that is used by a user to present images of live videos and is typically a home page of the application of live video broadcast; the interactive information page is a page that permits the interaction between a broadcaster of live video and each audience, a relevant user operation, such as swiping or point touch, done to the live video broadcast page can lead to entering into the interactive information page, and the embodiment of the application is not limited to thereto. The live video broadcast page and the interactive information page are interrelated to each other, and particularly, the audience who can watch the live video screen played in the live video broadcast page, and the broadcaster of the live video can visit the related interactive information page. That is, the live video broadcast page provides a platform for watching live videos, and the interactive information page provides a platform of interaction. The live program information page can show information about the broadcaster, audience of the live video broadcast and information about the start and end of the live video.

Herein, in the step of enabling the voice collection module when a continuous touch event occurring on a voice response control item in an interactive information page is detected, there is a voice response control item on the interactive information page, and it can be imagined that the voice response control item has a visualized symbol, such as a symbol of voice response, and may also have interaction information of text prompt by which a user prompts another user to do a related operation for a voice response. The user records audio information as consecutively touching and pressing the voice response control item, and particularly, a voice collection module for collecting the user's voice is automatically enabled when the user touches and presses the voice response control item.

Wherein a valid touch and press is defined to avoid that the user inadvertently touch the voice response control item, the valid touch and press is touching and pressing the continuous touch event for a period of time that is larger than a time threshold. When the duration of the continuous touch event is smaller than the time threshold, nothing is done or the voice collection module is still not enabled. In other embodiments of the application, the time threshold is 2 seconds. Moreover, to assure that the live video broadcast is proceeded normally, an upper limitation, e.g. 10 seconds, is typically defined for the duration of a continuous touch event. Note that the time threshold and the upper limitation of the duration of the continuous touch event can be freely set in the setting options of the user's live video broadcast according to the user's actual situation by the user.

The foregoing embodiment is merely a certain implementation of the application; and it can be imagined that other various implementations can be derived in the spirit of the application, and however, they should be considered an ideological scope of the application and full within the scope of the application.

In step S200 following the above step S100, collecting voice data by a voice collection module during the continuous touch event is immediately collecting the user's real-time voice data after the voice collection module is enabled. Moreover, the live video in broadcast is muted while the voice collection module collects the voice data. Note that when the voice collection module collects the voice data, only the sounds of the live video is muted but the images of the live video are still displayed, and the proceeding of the live video broadcast is not affected. Muting the live video can assure that the collected voice data is clear and accurate, so as to enhance user experiences.

In step S300 following the above step S200, the voice data is sent to an interaction platform; herein, the interaction platform is disposed at a server end for the live broadcast and is capable of collecting, transferring, sending a variety of data to a respective user who attempts watching live videos, and playing a role of a broadcaster who attempts broadcasting live videos. While the voice data is sent to the interaction platform, the interaction platform can push the voice data to a respective related user, wherein the related users include users who watch a live video at the same time, and a user who broadcasts the live video; herein, the users watching a live video at the same time are audience, which can includes a plurality of users that also includes the user sending the voice data; and the user broadcasting a live video is a broadcaster. Here, the related user may be provided with a prompt notification when receiving the voice data, and if the related user gives a text prompt on a running interface or gives a vibration prompt via an apparatus end of the related user to prompt the service of mutual trust information, the respective related user can immediately look over and respond to it, and the related user's response is carried out by the above method steps.

Voice data is corrected through an interactive information page of a application of live video broadcast by the voice collection module, is sent to the interaction platform by the sending module, and then is sent to an interactive information page of a respective related user by the interaction platform, so the related user can receive it for the voice interaction in a live video broadcast. This resolves resolve the technical problem at the present stage where applications of live broadcast permitting text type interaction lack timeliness, sufficient immediateness and friendliness, and also enhances user experiences. Moreover, the live video which the user is watching is muted in the duration of collecting the user's voice data, so as to assure that the voice data is clear and accurate, and thus, user experience can further be advanced.

The foregoing embodiments are merely some certain implementations of the application; and it can be imagined that other various implementations can be derived in the spirit of the application, and however, they should be considered an ideological scope of the application and full within the scope of the application.

### Embodiment 2

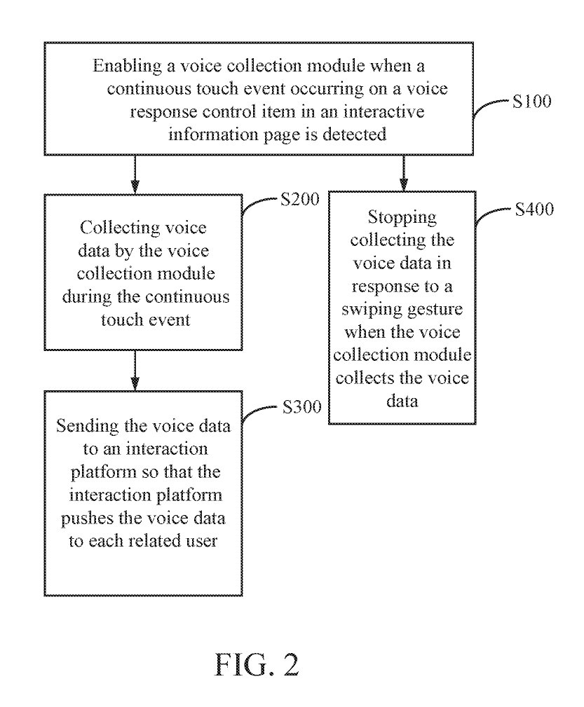

Please refer to FIG. 2, which is another flow chart of a method of implementing voice interaction in a live video broadcast in the Embodiment 2 of the application. This embodiment is based on the Embodiment 1, and after step S100 where the voice collection module is enabled as a continuous touch event occurring on a voice response control item in the interactive information page is detected, is performed, the method also includes:
step S400, stopping collecting the voice data in response to a swiping gesture when the voice collection module collects the voice data.

In step S400, receiving the voice data is stopped in response to a swiping gesture in the duration of ending the voice data after the voice collection module is enabled as a continuous touch event occurring on a voice response control item in the interactive information page is detected. Particularly, when the user tries to touch the voice response control item, the finger for touching the voice response control item can paint a trajectory on the screen of the apparatus, and the trajectory is referred to as a swiping gesture; and after the live voice application responds to the swiping gesture, the live voice application stops receiving the voice data, i.e. cancels this commentary.

Wherein if the user is walking, the mobile phone will be slightly rocked to cause that the reception of the voice data is canceled to lead to failure in commentary; and to avoid the user's inadvertent operation, the swiping gesture is defined to have the distance of trajectory longer than a threshold.

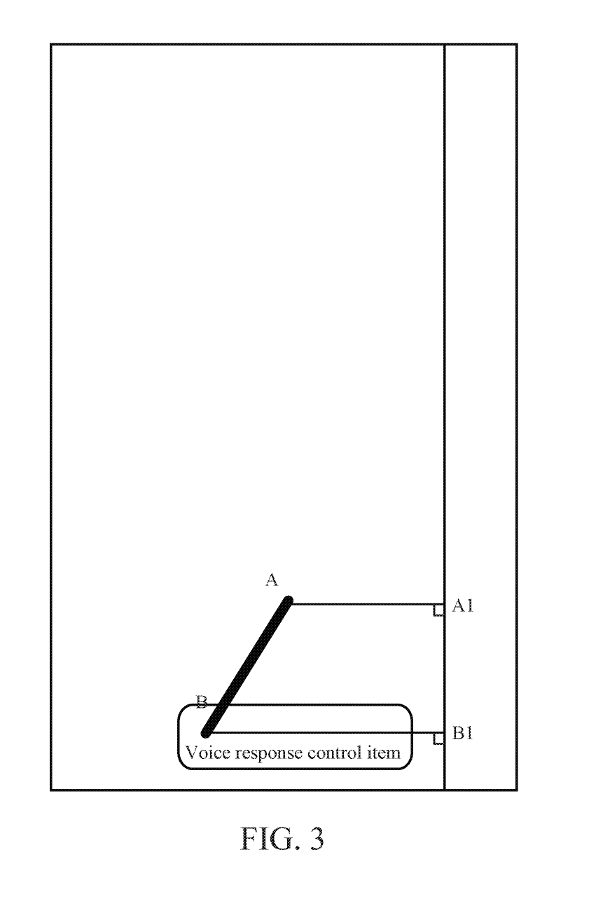

Herein, the swiping gesture is a swiping operation done by touching and pressing a voice response control item on the screen of a mobile phone by the user. Under consideration to the randomness of the swiping operation, the swiping trajectory may be upright or be inclined, and the inclined angle is not easy to control, and thus, only the valid distance of the trajectory of the swiping gesture is calculated. The valid distance is the projection of the swiping gesture in a vertical direction, and the projection of the swiping gesture in the vertical direction is larger than the projection of the swiping gesture in a horizontal direction. Please refer to FIG. 3, the trajectory of the swiping gesture is the line AB, the valid distance is the length of the line A1B1, and the thin solid line in the figure represents a vertical reference line of the screen of a mobile phone. For example, the length of the valid distance A1B1 of the trajectory AB of the swiping gesture is calculated to be 2 cm, and its particular calculation method can be carried out by trigonometric functions in the existing technology and thus, will not be described in detail in this embodiment hereafter. When the valid distance is larger than the threshold, receiving the voice data is stopped to cancel this commentary.

The user is permitted to cancel the collection of voice data to stop the voice interaction any time when collecting voice data, and thus, feeling free to comment and further advancing user experiences can be achieved.

### Embodiment 3

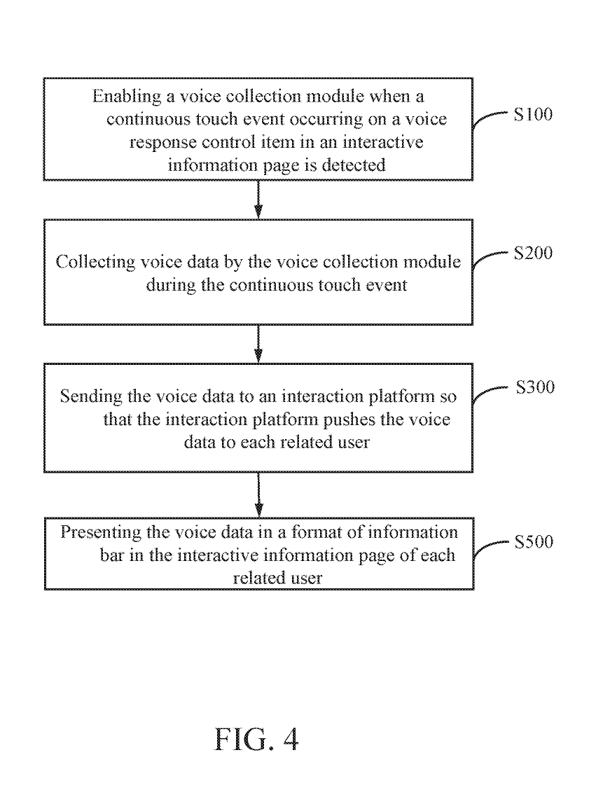

Please refer to FIG. 4, which is yet another flow chart of a method of implementing voice interaction in a live video broadcast in the Embodiment 3 of the application. This embodiment is based on the Embodiment 1. after the voice data is sent to the interaction platform so that the interaction platform pushes the voice data to a respective related user in step S300, the method further includes:
step S500, presenting the voice data in a format of information bar in the interactive information page of each related user, wherein length of the information bar has positive correlation with time indicated by the voice data.

In step 500, after the voice data is sent out and then is received by a respective related user, the voice data will be presented in the interactive information page of the respective related user, wherein the voice data is presented in a format of information bar, and the length of the information bar and the time indicated by the voice data have positive correlation therebetween. Here, the interactive information page can present the received voice data in a format of information bar, and the length of the information bar and the time corresponding to the data language have positive correlation therebetween. That is, the longer the length of the information bar, the more the time corresponding to the language data. In other preferred embodiments of the application, the time, corresponding to the language data and using the second as a unit of time, can be shown in a suitable position on the information bar. Moreover, presenting the information bar in the interactive information page of a respective related user includes that a sender of the voice data is both the receiver of the audience receiving the live video and the broadcaster broadcasting the live video.

The foregoing embodiment is merely a certain implementation of the application; and it can be imagined that other various implementations can be derived in the spirit of the application, and however, they should be considered an ideological scope of the application and full within the scope of the application.

### Embodiment 4

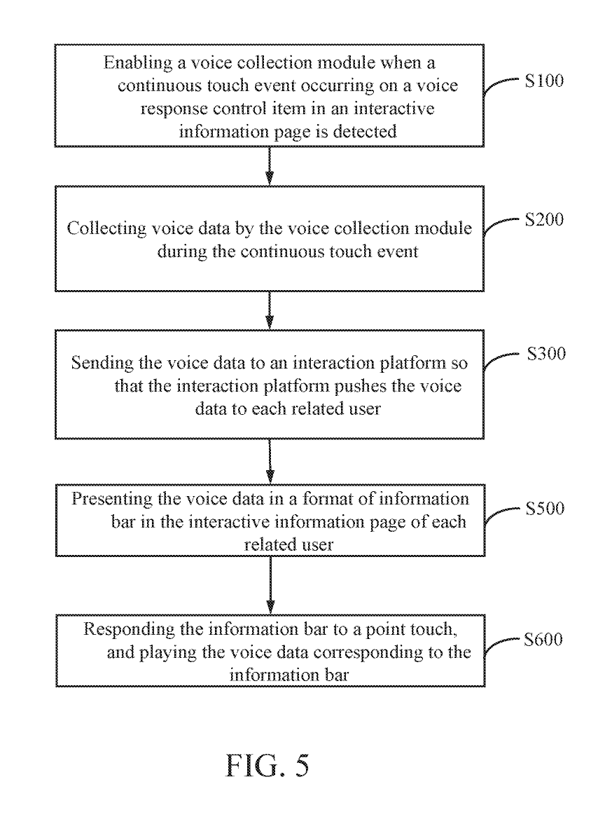

Please refer to FIG. 5, which is yet another flow chart of a method of implementing voice interaction in a live video broadcast in the Embodiment 4 of the application. This embodiment is based on the Embodiment 3, and after the voice data is presented in a format of information bar in the interactive information page of the related user in step S500, the method further includes:
step S600, responding the information bar to a point touch, and playing the voice data corresponding to the information bar.

In step S600, after the interactive information page of the related user presents the information bar and the information bar responds to a point touch, an audio player is enabled to play the voice data corresponding to the information bar. As described above, the sender of the voice data that is both the receiver of the audience receiving the live video and the broadcaster broadcasting the live video can perform the play of the voice data corresponding to the information bar. The point touch is a click or touch done on the screen by the user. It can be understood that other play manners may be contemplated that in an example, the voice data corresponding to the information bar is automatically played after the interactive information page of the related user presents the information bar.

The foregoing embodiments are merely some certain implementations of the application; and it can be imagined that other various implementations can be derived in the spirit of the application, and however, they should be considered an ideological scope of the application and full within the scope of the application.

### Embodiment 5

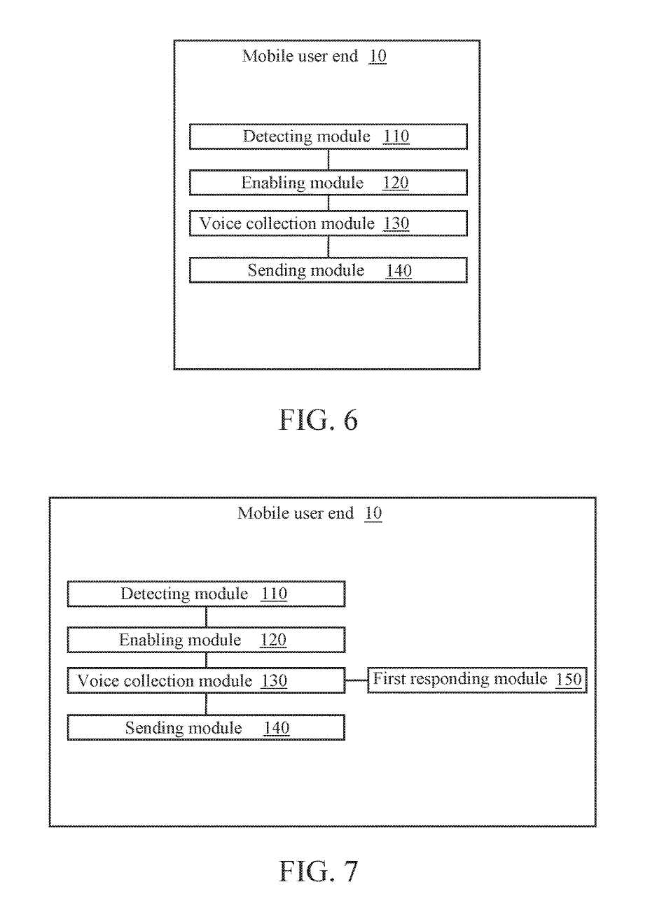

To resolve the technical problem at the present stage where applications of live broadcast permitting text type interaction lack timeliness, sufficient immediateness and friendliness, the Embodiment 5 of the application provides an electronic apparatus of implementing voice interaction in a live video broadcast. The electronic apparatus is an application of live video broadcast, which can be installed on a smart terminal such as a smart mobile phone or tablet computer, which is capable of being installed with applications, and the application is not restricted to the type of the smart terminal. Embodiments of the application are described based on the case of a smart phone. Please refer to FIG. 6, which is a block diagram of an electronic apparatus of implementing voice interaction in a live video broadcast in the Embodiment 6 of the application. The electronic apparatus 10 includes a detecting module 110, an enabling module 120, a voice collection module 130 and a sending module 140.

The detecting module 110 is configured to detect a continuous touch event occurring on a voice response control item in an interactive information page, wherein the interactive information page and the live video broadcast page are interrelated to each other.

The enabling module 120 is configured to enable the voice collection module 130 after the detecting module detects the continuous touch event occurring on the voice response control item in the interactive information page.

The voice collection module 130 is configured to collect voice data in duration of the continuous touch event, and the live video broadcast page stays in a muted state when the voice collection module collects the voice data.

The sending module 140 is configured to send the voice data to an interaction platform so that the interaction platform pushes the voice data to each related user, wherein the related users include a user watching live video and a user broadcasting live video.

Wherein the duration of the continuous touch event is larger than a time threshold.

Voice data is corrected through an interactive information page of a application of live video broadcast by the voice collection module, is sent to the interaction platform by the sending module, and then is sent to an interactive information page of a respective related user by the interaction platform, so the related user can receive it for the voice interaction in a live video broadcast. This resolves the technical problem at the present stage where applications of live broadcast permitting text type interaction lack timeliness, sufficient immediateness and friendliness, and enhances user experiences. Moreover, the live video which the user is watching is muted in the duration of collecting the user's voice data, so as to assure that the voice data is clear and accurate, and thus, user experience can further be advanced.

### Embodiment 6

Please refer to FIG. 7, which is another block diagram of an electronic apparatus of implementing voice interaction in a live video broadcast in the Embodiment 6 of the application. This embodiment is based on the Embodiment 5, and the electronic apparatus 10 further includes a first responding module 150.

The first responding module 150 is configured to stop receiving the voice data in response to a swiping gesture when the voice collection module collects the voice data, wherein a distance of trajectory of the swiping gesture is longer than a threshold.

The user is permitted to stop the collection of voice data to end the voice interaction any time in the duration of collecting voice data, so as to feel free to commentary and further enhance user experiences.

### Embodiment 7

Please refer to FIG. 8, which is yet another block diagram of an electronic apparatus of implementing voice interaction in a live video broadcast in the Embodiment 7 of the application. This embodiment is based on the Embodiment 5, and the electronic apparatus 10 further includes a display module 160.

The display module 160 is configured to present the voice data in a format of information bar in the interactive information page of the related user, wherein length of the information bar has positive correlation with time indicated by the voice data.

### Embodiment 8

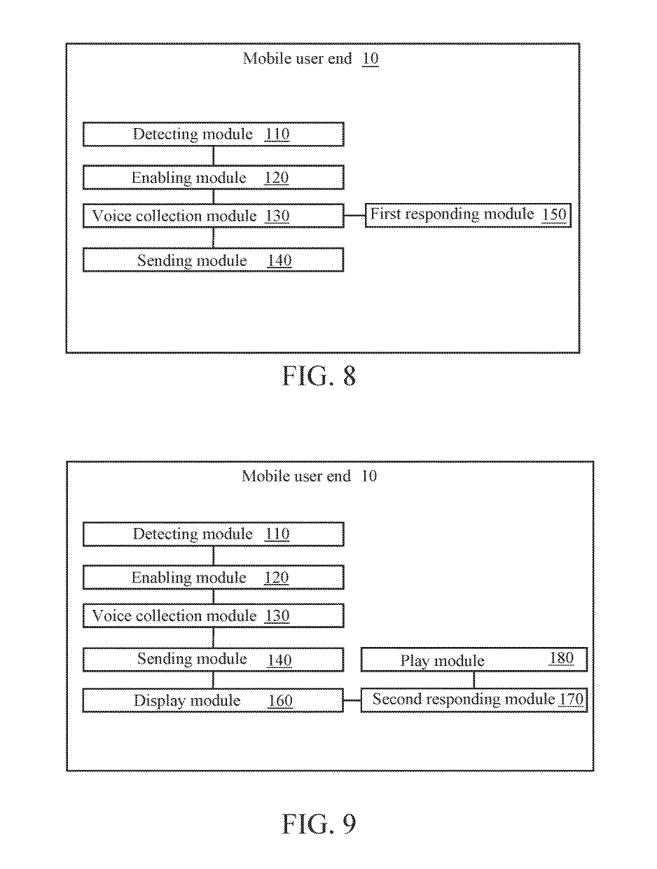

Please refer to FIG. 9, which is yet another block diagram of an electronic apparatus of implementing voice interaction in a live video broadcast in the Embodiment 8 of the application. This embodiment is based on the Embodiment 7, and the electronic apparatus 10 further includes a second responding module 170 and a play module 180.

The second responding module 170 is configured to respond the information bar to a point touch.

The play module 180 is configured to play the voice data corresponding to the information bar after the second responding module responds the information bar to a point touch.

If the above embodiment of the electronic apparatus of implementing voice interaction in a live video broadcast is unclear somewhere, please refer to the forgoing embodiments of the method of implementing voice interaction in a live video broadcast.

### Embodiment 9

This Embodiment 9 provides a non-volatile computer storage medium, which stores computer-executable instructions, and the computer-executable instructions can execute any of method embodiments of the method of implementing voice interaction in a live video broadcast.

### Embodiment 10

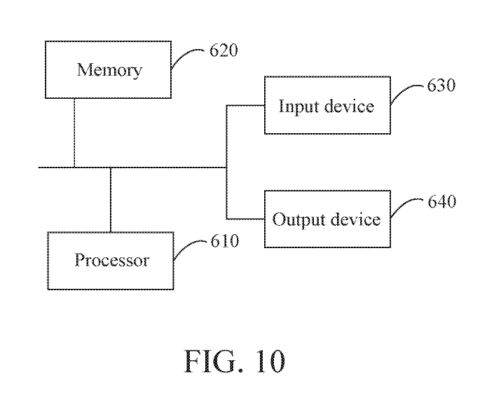

FIG. 10 is a structural diagram of hardware of an electronic apparatus of executing the method of implementing voice interaction in a live video broadcast provided in the Embodiment 7. As shown in FIG. 10, the apparatus includes:
one or more processors 610 and a storage 620, wherein one processor 610 is exemplified as shown in FIG. 6.

The apparatus of executing the method of implementing voice interaction in a live video broadcast further includes: an input device 630 and an output device 640.

The processor 610, the storage 620, the input device 630 and the output device 640 can be connected to each other via bus or other manners, and the connections are exemplarily carried out by bus in FIG. 6.

The storage 620 as a non-volatile computer-readable storage medium can be used for storing a non-volatile software program, non-volatile computer-executable program and module, such as program instructions/module corresponding to the method of implementing voice interaction in a live video broadcast in this embodiment (e.g. the detecting module 110, the enabling module 120, the voice collection module 130, the sending module 140 as shown in FIG. 6). The processor 610 executes a variety of function applications and the data process of the electronic apparatus by running the non-volatile software program, instructions and module stored in the storage 620, to carry out the method of implementing voice interaction in a live video broadcast in the above method embodiments.

The storage 620 can include a program storage area and a data storage area, wherein the program storage area can store an operating system and at least one application program required for a function; the data storage area can store the data created according to the use of a device of implementing voice interaction in a live video broadcast. Moreover, the storage 620 can include a high speed random-access storage, and further include a non-volatile storage, such as at least one disk storage member, at least one flash memory member and other non-volatile solid state storage member. In some embodiments, the storage 620 can be selected from storages having a remote connection with the processor 610, and these remote storages can be connected to a device of implementing voice interaction in a live video broadcast by a network. The aforementioned network includes, but not limited to, internet, intranet, local area network, mobile communication network and combination thereof.

The input device 630 can receive digital or character information, and generate a key signal input corresponding to the user setting and the function control of a device of implementing voice interaction in a live video broadcast. The output device 640 can include a display apparatus such as a screen.

The one or more modules are stored in the storage 620, and the one or more modules execute a method of implementing voice interaction in a live video broadcast in any of the above method embodiments when executed by the one or more processors 610.

The aforementioned product can execute the method in the embodiments, and has functional modules and beneficial effect corresponding to the execution of the method. The technical details not described in the embodiments can be referred to the method provided in the embodiments of the application.

The electronic apparatus in the embodiments of the present application is presence in many forms, and the electronic apparatus includes, but not limited to:

(1) mobile communication apparatus: characteristics of this type of device are having the mobile communication function, and providing the voice and the data communications as the main goal. This type of terminals include: smart phones (e.g. iPhone), multimedia phones, feature phones, and low-end mobile phones, etc.

(2) ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) server: an apparatus provide computing service, the composition of the server includes processor, hard drive, memory, system bus, etc, the structure of the server is similar to the conventional computer, but providing a highly reliable service is required, therefore, the requirements on the processing ability, stability, reliability, security, scalability, manageability, etc. are higher.

(5) other electronic apparatus having a data exchange function.

The described apparatus embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments. A person of ordinary skill in the art may understand and implement the technical solution without creative works.

With the description of the above embodiments, those skilled in the art can understand clearly that, the methods according to the above embodiments can be implemented by means of software plus a necessary general-purpose hardware platform, and of course can be implemented by hardware. Based on such understanding, the technical solutions of the present disclosure essentially or a part of the technical solutions of the present disclosure which makes contribution to the related art can be embodied in a form of a software product, and the computer software product is stored in a computer readable storage medium, such as a ROM/RAM, a magnetic disc, an optical disk or the like, and includes some instructions to cause a computer apparatus which may be a personal computer, a server, network equipment, or the like to implement the method or a part of the method according to the respective embodiments.

Finally, it should be noted that the foregoing embodiments are merely intended for describing the technical solutions of the application rather than limiting the application. Although the application is described in detail with reference to the foregoing embodiments, persons of ordinary skill in the art should understand that they may still make modifications to the technical solutions recorded in the foregoing embodiments or make equivalent replacements to part of technical features of the technical solutions recorded in the foregoing embodiments; however, these modifications or replacements do not make the essence of the corresponding technical solutions depart from the spirit and scope of the technical solutions of the embodiments of the application.

What is claimed is:

1. A method of implementing voice interaction in a live video broadcast, applied to a terminal and comprising:
enabling a voice collection module when a continuous touch event occurring on a voice response control item in an interactive information page is detected, wherein the interactive information page and a live video broadcast page are interrelated to each other;
collecting voice data by voice collection module during the continuous touch event, and the live video broadcast page staying at muted state when the voice collection module collects the voice data;
sending the voice data to an interaction platform so that the interaction platform pushes the voice data to each related user, wherein the related users comprise a user watching live video and a user broadcasting live video.

2. The method of implementing voice interaction in the live video broadcast according to claim 1, wherein that duration of the continuous touch event is larger than a time threshold.

3. The method of implementing voice interaction in the live video broadcast according to claim 1, further comprising:
stopping collecting the voice data in response to a swiping gesture when the voice collection module collects the voice data.

4. The method of implementing voice interaction in the live video broadcast according to claim 3, wherein a distance of trajectory of the swiping gesture is longer than a threshold.

5. The method of implementing voice interaction in the live video broadcast according to claim 1, further comprising:
presenting the voice data in a format of information bar in the interactive information page of the related user, wherein length of the information bar has positive correlation with time indicated by the voice data.

6. A non-volatile computer storage mechanism, storing computer-executable instructions which are configured to:
enable a voice collection module when a continuous touch event occurring on a voice response control item in an interactive information page is detected, wherein the interactive information page and a live video broadcast page are interrelated to each other;
collect voice data by voice collection module during the continuous touch event, and the live video broadcast page staying at muted state when the voice collection module collects the voice data;
send the voice data to an interaction platform so that the interaction platform pushes the voice data to each related user, wherein the related users comprise a user watching live video and a user broadcasting live video.

7. An electronic apparatus, comprising:
at least one processor; and,
and a storage communicating with the at least one processor; wherein,
the storage storing instructions executable by the at least one processor, and when executed by the at least one processor, the instructions making the at least one processor perform:
enable a voice collection module when a continuous touch event occurring on a voice response control item in an interactive information page is detected, wherein the interactive information page and a live video broadcast page are interrelated to each other;
collect voice data by voice collection module during the continuous touch event, and the live video broadcast page staying at muted state when the voice collection module collects the voice data;
send the voice data to an interaction platform so that the interaction platform pushes the voice data to each related user, wherein the related users comprise a user watching live video and a user broadcasting live video.

8. The non-volatile computer storage mechanism according to claim 6, wherein duration of the continuous touch event is larger than a time threshold.

9. The non-volatile computer storage mechanism according to claim 6, wherein the computer-executable instructions are further configured to:
stop collecting the voice data in response to a swiping gesture when the voice collection module collects the voice data.

10. The non-volatile computer storage mechanism according to claim 8, wherein a distance of trajectory of the swiping gesture is longer than a threshold.

11. The non-volatile computer storage mechanism according to claim 6, wherein the computer-executable instructions are further configured to:
present the voice data in a format of information bar in the interactive information page of the related user, wherein length of the information bar has positive correlation with time indicated by the voice data.

12. The electronic apparatus according to claim 7, wherein duration of the continuous touch event is larger than a time threshold.

13. The electronic apparatus according to claim 7, the processor is further able to:
stop collecting the voice data in response to a swiping gesture when the voice collection module collects the voice data.

14. The electronic apparatus according to claim 13, wherein a distance of trajectory of the swiping gesture is longer than a threshold.

15. The electronic apparatus according to claim 7, the processor is further able to:
present the voice data in a format of information bar in the interactive information page of the related user, wherein length of the information bar has positive correlation with time indicated by the voice data.
